(19) United States
(12) Patent Application Publication
(10) Pub. No.: US 2006/0136554 A1
(43) Pub. Date: Jun. 22, 2006

(54) Information server in a communication system

(75) Inventors: Jaakko Rajaniemi, Helsinki (FI); Johan Wikman, Helsingfors (FI); Ferenc Dosa, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/079,390

(22) Filed: Mar. 15, 2005

(30) Foreign Application Priority Data
Dec. 22, 2004 (FI) 20041654

(51) Int. Cl. G06F 15/16

(52) U.S. Cl. 709/203

(57) ABSTRACT

A method provides monitoring access to an information server. The method comprises receiving an attempt to access an information server. The method further comprises determining whether the information server is available. The method further comprises informing that the information server is not available, if the information server is not available. The method further comprises storing information relating to the attempt. Furthermore, a gateway, an information server, a communication system and a computer program are configured to execute the method.

### FIELD OF THE INVENTION

The invention relates to communication systems, and more specifically to information servers. In particular, the invention relates to mobile information servers implemented in mobile communication devices. Furthermore, the invention relates to monitoring and managing access to the information server.

### BACKGROUND OF THE INVENTION

A communication system can be seen as a facility that enables communication sessions between two or more entities such as one or more communication devices and/or other nodes associated with the communication system. A communication system typically operates in accordance with a given standard or specification setting out what the various entities associated with the communication system are permitted to do and how that should be achieved. A standard or specification may define a specific set of rules, such as communication protocols and/or parameters, on which connections between the entities can be based.

Wireless communication systems include various cellular or otherwise mobile communication systems using radio frequencies for sending voice or data between stations, for example between a communication device and a transceiver network element. Examples of wireless communication systems may comprise public land mobile network (PLMN), such as global system for mobile communication (GSM), the general packet radio service (GPRS) and the universal mobile telecommunications system (UMTS). Further examples of wireless communication systems may comprise wireless local area network (WLAN), wireless packet switched data networks, such as a wireless Internet Protocol (IP) network and so on.

A mobile communication network may logically be divided into a radio access network (RAN) and a core network (CN). The core network entities typically include various control entities and gateways for enabling communication via a number of radio access networks and also for interfacing a single communication system with one or more communication systems, such as with other wireless systems and/or fixed line communication systems. Examples of radio access networks may comprise the UMTS terrestrial radio access network (UTRAN) and the GSM/EDGE radio access network (GERAN).

Subscribers, such as the users or end-users, to a communication system may be offered and provided numerous services, such as calls, data communication or multimedia services or simply an access to a network, such as the Internet. Servers may be used in provision of the services and may be operated by an operator of a network or by an external service provider. For example, a mobile communication device may allow a user thereof to browse the Internet. For example, the wireless application protocol (WAP) provides mobile communication devices wireless services over the Internet from fixed information servers, such as Internet servers and Web servers.

Recently, it has been proposed that an information server, such as a Web server, might be implemented in a mobile communication device or mobile terminal. A server implemented in a mobile terminal, i.e. a mobile server, may enable various new uses, such as immediate sharing of pictures taken by the user of the terminal and so on. In this context, a mobile server may be defined in other words as non-fixed or non-stationary server.

A U.S. patent application Ser. No. 10/611,647, filed on 1^{st} Jul. 2003, in the name of Qu, describes a system, apparatus and method for providing a mobile information server providing information resources as a HTTP server.

However, implementing an information server in a mobile terminal may create new problems. For example, current stationary Web servers are typically assumed to be up, such as providing services, all the time. It is an unwanted and even exceptional event for both the service provider and a user that a Web server is down. However, when the server is implemented in a mobile communication, the server may be out of use in various situations arriving even relatively often. Examples of such situations may comprise, but are not limited to, a power source of the communication device runs out of power, a user of the communication device switches the device off, a connection to the communication system is lost temporarily, and so on.

Therefore, there is a need to provide mobile servers with new features relating for example to situations when the mobile server is not available.

It shall be appreciated that these issues are not limited to any particular communication environment, but may occur in any appropriate communication system.

### SUMMARY OF THE INVENTION

In accordance with an aspect of the invention, there is provided a method for monitoring access to an information server. The method comprises receiving an attempt to access an information server. The method further comprises determining whether the information server is available. The method further comprises informing that the information server is not available, if the information server is not available. The method further comprises storing information relating to the attempt.

In accordance with a further aspect of the invention, there is provided a gateway for monitoring access to an information server in a communications system. The gateway is configured to receive an attempt to access an information server. The gateway is further configured to determine whether the information server is available. The gateway is further configured to inform that the information server is not available, if the information server is not available. The gateway is further configured to store information relating to the attempt.

In an embodiment, information relating to a party, from which the attempt was received, may be stored. In an embodiment, said party may be enquired whether the party requests to be sent a notification when the information server becomes available. In an embodiment, enquiring may comprise enquiring an address information relating to an address where said party requests to be informed. In an embodiment, enquiring may comprise providing one of a form to be filled in and a selectable form. The form may be a hypertext markup language form. In an embodiment, a response may be in response to the step of enquiring.

In an embodiment, availability information informing that the information server is available may be received. A notification may be sent to the party, from which the attempt was received, when the availability information is received. The notification may be sent by means of at least one of short message service, multimedia messaging service, electronic mail and instant messaging, for example using session initiation protocol.

In an embodiment, the information relating to the attempt may be provided to the information server. In an embodiment, the information relating to the attempt to the information server may be provided to the information server owner.

In an embodiment, the information server may be a mobile information server.

In accordance with a further aspect of the invention, there is provided a method for managing an information server. The method comprises receiving information relating to an attempt to access an information server, which attempt occurred during a period of unavailability of the information server. The method further comprises informing that the information server is available again.

In accordance with a further aspect of the invention, there is provided an information server for a communication system. The information server is configured to receive information relating to an attempt to access an information server, which attempt occurred during a period of unavailability of the information server. The information server is further configured to inform that the information server is available again.

In accordance with a further aspect of the invention, there is provided a computer program comprising program code means for performing any of the steps according to embodiments of the invention when the program is run on a computing means.

### BRIEF DESCRIPTION OF THE DRAWINGS

The invention will now be described in further detail, by way of example only, with reference to the following examples and accompanying drawings, in which:

FIG. 1 shows an example of an arrangement in which the embodiments of the invention may be implemented;

FIG. 2 shows a further example of an arrangement in which the embodiments of the invention may be implemented;

FIGS. 3a-3d show signaling charts of embodiments of the invention; and

FIG. 4 shows a flow chart illustrating an embodiment of the invention.

### DETAILED DESCRIPTION OF PREFERRED EMBODIMENTS

Embodiments of the invention are now illustrated in association with a mobile network. A mobile communication network, such as a GPRS or an UMTS network, is typically arranged to serve a plurality of mobile communication devices usually via a wireless interface between a mobile communication device and at least one transceiver network element of the communication network, such as a base transceiver station (BTS) or a Node B. A transceiver network element typically serves a geographical area or a plurality of geographical areas. Such a geographical area may also be referred to as a cell. One or more transceiver network elements may be controlled by a controller network element, such as a base station controller (BSC) or a radio network controller (RNC). The mobile communication system may logically be divided between a radio access network (RAN) and a core network (CN).

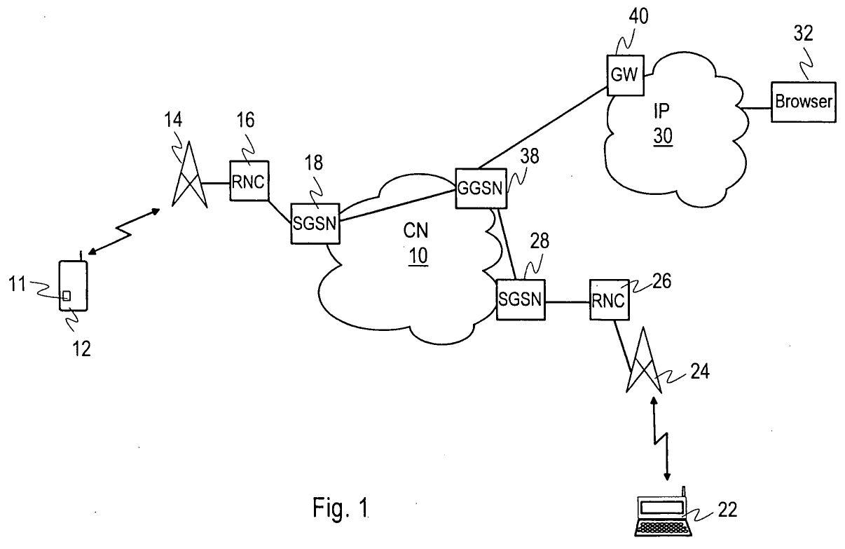

Reference is made to FIG. 1 showing an example of a network architecture in which the embodiments of the invention may be implemented. In FIG. 1, a mobile communication device 12 is arranged to access a communication core network 10 via a radio access network comprising a transceiver network element 14 and a controller network element 16. The communication device 12 is arranged to transmit signals to and receive signals from the transceiver network element 14 via a wireless interface between the communication device and the transceiver network element. Correspondingly, the transceiver network element is able to transmit signals to and receive signals from the communication device via the wireless interface.

Furthermore, a communication device 22 is arranged to access the core network via a radio access network comprising a transceiver network element 24 and a controller network element 26.

It shall be appreciated that, although only two communication devices are shown in FIG. 1 for clarity, a number of communication devices may be in simultaneous communication with one or more transceiver network elements of a communication system. Furthermore, although for clarity FIG. 1 shows only two exemplifying transceiver network elements and two exemplifying controller network elements, a typical communication network system usually includes a number of radio access networks. A controller may be assigned for each transceiver network element or a controller can control a plurality of transceiver network elements, for example in the radio access network level. It shall be appreciated that the name, location and number of the network controllers may vary depending on the system.

The core network (CN) entities typically include various switching and other control entities and gateways for enabling the communication via a number of radio access networks and also for interfacing a single communication system with one or more communication systems, such as with other cellular systems and/or fixed line communication systems. The radio access network controller is typically connected to an appropriate core network entity or entities such as, but not limited to, a serving general packet radio service support node (SGSN) 18, 28. The radio access network controller 16, 26 is in communication with the SGSN 18, 28 via an appropriate interface, for example on an Iu or Gb interface.

The SGSN is responsible for delivery of data packets to and from the communication devices within a service area. The SGSN may perform packet routing and transfer, mobility management, logical link management, authentication, charging functions, and so on. The SGSN may store location information of a communication device, such as the current cell and a visiting location register (VLR) associated with the communication device. Furthermore, the SGSN may store information on user profiles, such as the International Mobile Subscriber Identity Number (IMSI) of all the communication devices registered with the SGSN.

Furthermore, a gateway GPRS support node (GGSN) 38 may act as a gateway between the core network 10 and other communication systems, such as an IP network 30. A gateway 40, such as a HTTP proxy or a WAP proxy, is also shown connected to the GGSN 38. The gateway may provide means for handling mobility, provide a firewall and addressing and so on. Furthermore, embodiments of the invention may be performed at least in part in the gateway 40. The operation of the exemplifying gateway 40 will become clear from the following description. The gateway 40 may be placed in an appropriate location in the communication system. The gateway 40 may be in the exemplifying IP network 30 as shown in FIG. 1. In an alternative, the gateway 40 may locate in the core network. Other alternative architectures may be possible as well.

An end-user may access a communication network by means of any appropriate communication device, also called terminal. Examples may comprise user equipment (UE), a mobile station (MS), a cellular phone, a personal digital assistant (PDA) and a personal computer (PC). Further examples may comprise any other equipment operable according to a suitable network or transport protocol, such as a Session Initiation Protocol (SIP), a Real-Time Transmission Protocol (RTP), a File Delivery over Unidirectional Transport (FLUTE), a wireless applications protocol (WAP) or a hypertext transfer protocol (HTTP).

A communication device may be provided with an antenna or other such transceiver and receiver means for wirelessly receiving and transmitting signals from and to a transceiver network element of a wireless communication system. A communication device may also be provided with a display and a speaker. The operation of a communication device may be controlled by means of a suitable user interface comprising control means, such as a keypad, voice commands, touch sensitive screen or pad, or combinations thereof, or the like. The user interface may display a user a menu, a list or the like and allow the user to select an option from the menu. The user may indicate the selection by using the control means. The user interface may detect user activity and communicate the selection to a communicating logic of the communication device. A communication device is typically provided with a processor and memory means as well as software and applications operating the device and enabling operation with other entities. Software, which is able to request services from other entities in a communication system, may be called a client.

A communication system may support the session initiation protocol (SIP) as developed by the Internet engineering task force (IETF). The SIP is an application layer control protocol for creating, modifying and terminating sessions with one or more participants, i.e. end-points. A user connected to a SIP base communication system may communicate with various entities of the communication system based on standardized SIP messages. Communication devices or users who run certain applications on the communication devices are registered with the SIP backbone so that an invitation to a particular session can be correctly delivered to these end points. Uniform Resource Identifiers (URIs) are used to identify different types of actors in a SIP-controlled network. Typically a URI points to a registered user identity of an individual user. A URI may identify also services or other types of resources.

In embodiments of the invention, an information server 11, such as a Web server or Web services provider functionality, is implemented in the mobile communication device 12. The mobile communication device 12 hosting the information server 11 shall be called herein also a web server mobile terminal 12.

For example, for implementing the information server in the mobile communication device, the principles disclosed in the U.S. patent application Ser. No. 10/611,647 (referred to as U.S. Ser. No. 10/611,647 herein) may be used. An exemplifying implementation based on the U.S. Ser. No. 10/611,647 is summarized in the following with reference to FIG. 1. However, it shall be understood by a skilled person that other ways of implementing a web server in a mobile terminal may be used in embodiments of the invention.

The web server mobile terminal 12 may provide information resources and act as an HTTP server. Other terminals operating as HTTP clients may comprise web services clients (WSC), such as a client in the mobile communication device 22, or Internet browsers 32 operating within the IP network 30. The HTTP clients may access information provided in the server 11 through the use of HTTP. A client requesting to access the information provided in the server 11 may also be called a requesting client relating to a requesting terminal herein. The web server mobile terminal 12 may, for example, be used for publishing an information resource, such as a home page in wireless markup language (WML), hypertext markup language (HTML) or extensible hypertext markup language (XHTML), or image or video content, or the like. A user of the web server mobile terminal 12 may further define access controls to the information resource.

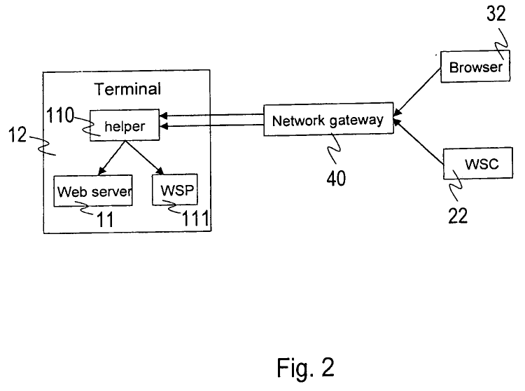

FIG. 2 shows more in detail an embodiment for implementing the web server (HTTP server) 11 and/or a web services provider (WSP) process 111 in the web server mobile terminal 12. An HTTP request may be generated by a client, such as the WSC in the mobile communication device 22, and be delivered to the HTTP server 11 in the web server mobile terminal 12. The request may pass though the gateway 40 towards a processor means, such as a helper 110, in the web server mobile terminal 12. The helper 110 may forward the request to the web server 11 or to a web service provider (WSP) 111. In an embodiment, the helper 110 may be omitted and the request may pass directly to the to the HTTP server 11 or the WSP 111. One or more web services providers may be associated with the web server 11. An example of a service provided by an exemplifying WSP may comprise, but is not limited to providing location information. Web services provider may respond with HTTP including a simple object access protocol (SOAP) or, more generally, extensible markup language (XML) body.

The HTTP request may comprise a request line defining a method to be applied to the resource, the URI of the resource and the protocol version used. The HTTP request may comprise further components, such as a general header having general applicability to request and response messages, a request header allowing a client to pass additional information about the request, an entity header defining meta-information about an entity body and a message body carrying the entity body associated with the request, and/or other further components.

An exemplary HTTP request line using a “GET” tag indicating the method to be applied to the resource according to the prior art may be as follows: GET http://www.w3.org/pub/WWW/TheProject.html HTTP/1.1

The exemplary request line includes the familiar URI pathname, http://www.w3.org/pub/WWW/”. The file “TheProject.html” is to be retrieved as a result of the “GET” request from the URI. Mobile terminals, however, typically do not have an IP address or a URI associated with them. Therefore, HTTP GET request-line as indicated above is not compatible with, for example, mobile terminal 12, when content is desired to be retrieved from mobile terminal 12.

In embodiments of the invention, the proposed URI pathname used in an HTTP GET request from the mobile communication device 22, for example, may take a form of “http://www.domain-name/identifier” or “http: identifier.domain-name”. The “identifier” portion of the URI pathname reflects the identity of the web server mobile terminal 12 and the “domain-name” portion of the URI pathname reflects the domain name of a gateway 40 in the network. The identifier can be user's name, nick name, MSISDN or any other identifier which identifies the communication device of the user.

After receiving the HTTP request, the gateway 40 may proxy the request to mobile terminal 12, for example via GPRS network as tunneled IP data or other communication means, e.g. SIP, MMS, WAP Push or a short message service (SMS) (not shown) or another appropriate path. In an embodiment, the gateway 40 may additionally send the MSISDN of mobile terminal 22 to mobile terminal 12 for authentication and authorization of mobile terminal 22.

Data access from the web server mobile terminal 12 may be performed in a number of different ways, for example, by tunneling the data between the mobile terminal 12 and the gateway 40 using IP techniques. In other words, normal HTTP traffic may be tunneled between the mobile terminal 12 and the gateway 40. (Moreover, the technology of delivering the data between mobile terminal and gateway can be anything if the terminal and the gateway have a common knowledge of it.) This is possible because the mobile terminal 12 needs to register or inform about itself to the gateway 40 and set-up said tunneling in order to be available to external devices. In an embodiment, also the HTTP request may go directly to the server, if the gateway is not needed in the system.

However, it may happen that the web server mobile terminal is off-line, no bearer can be implemented and other users cannot reach the server functionality. It has now been found that it might be desirable to provide means for informing other users when the server becomes available again. For example, the server may become available again once a user of the web server mobile terminal activates the server in the terminal, when the terminal is switched on or when the terminal comes back to a service area from a shadow zone, and so on.

Moreover, it has been found that it might be beneficial to provide the user of the web server mobile terminal knowledge of access attempts to the server while the server was unavailable.

In embodiments of the invention, the gateway 40 may act as a HTTP proxy, or a reverse HTTP proxy, over which HTTP traffic goes between the mobile server and the browsing user. The gateway 40 may be coupled with a database and enhanced with the capability to perform searches on the collected data and make use of the collected data when desired or needed.

In an embodiment, the gateway 40 includes a functionality observing attempts to access the web server in the mobile terminal 12. When the web server mobile terminal 12 cannot be reached, the gateway 40 may inform the requesting terminal, in this case from the mobile communication device 22, that the web server in the mobile terminal 12 is not available. Said informing may comprise default information, such as a default message. In an embodiment, a user of the mobile terminal 12, or an owner of the information server 11, may define temporary or permanent data for creating said information in the gateway 40. In other words, the gateway 40 may turn from a proxy to a content provider generating and/or providing content to the requesting terminal. The content may be generated and/or provided based on the temporary or permanent data defined or set by the owner of the information server.

The term owner of the information server used in this specification is not limited to an entity strictly owning the server, but the term may cover herein a subscriber or user of the mobile terminal, an administrator of the information server, a mobile publisher or other such entity having a control of the information server.

Furthermore, the gateway 40 may ask the requesting terminal 22 whether the requesting terminal 22 requests to be informed when the web server in the mobile terminal 12 becomes available again. Furthermore, the gateway 40 may send a selectable form or a form to be filled in, such as a HTML form, to the requesting terminal 22 for giving required information. A user of the requesting terminal 22 may be asked to input an address, such as an e-mail, SIP address or an MSISDN, where to send a notification about availability of the web server in the mobile terminal 12.

Furthermore, the user of the requesting terminal 22 may be asked to input a note to be forwarded to the information server 11 when the server becomes available again.

In case of web services, the gateway may send a SOAP or XML response to the web services client, which response may describe the unavailability of the web services provider. Moreover, the response may contain information how to get notified when the web services provider comes back to online. This may require the web services client to perform a further web services call to subscribe to the event of the availability status (in other words, online/offline) of the web services provider.

Furthermore, the response may contain information on how to leave a note or message to an owner or user of the web services provider.

If a user of the requesting terminal 22 selects to request to be informed when the web server in the mobile terminal 12 becomes available again, the user may give the required information and send the required information to the gateway 40.

If a user of the requesting terminal 22 selects to leave a note, the user may give the required information and send the required information to the gateway 40.

The gateway 40 may store information received from one or more requesting terminals. Furthermore, the gateway 40 may record all the attempts to access the web server the gateway observes. In an embodiment, the gateway 40 only records the attempts associated with requesting terminals, which have requested to be informed when the web server in the mobile terminal 12 becomes available again and/or which have selected to leave a note.

When the web server in the mobile terminal 12 becomes available, for example is activated by the owner of the terminal, the web server performs registration of the web server to the gateway 40 for setting up tunneling from the gateway 40 to the mobile terminal 12. In connection with the registration, the gateway 40 obtains information that the web server has become available again.

In an embodiment, the gateway 40 may thus send a notification to the one or more requesting terminals, such as the requesting terminal 22, which have requested to be informed when the web server in the mobile terminal 12 becomes available again. A notification may be send to the requesting terminal 22, for example, by means of SMS, multimedia messaging service (MMS), electronic mail (e-mail) or SIP. In an embodiment, the user may fetch information of when the web server in the mobile terminal 12 has become or is becoming available again from the gateway 40, for example, by browsing to get the information.

An exemplifying form of the notification may be: “The mobile server is currently down. If you want to be notified, please send a notification address in return.” When the information server becomes available, the notification may be of an exemplifying form: “The mobile server is now available.” It shall be appreciated that a skilled person may formulate various different types and contents for the notification. The above example is given only for illustrative purposes and is not intended to limit different possibilities to provide the notification, but any other appropriate forms of notifications may be used in embodiments of the invention.

In an embodiment, the information sent to the one or more requesting terminals, such as the requesting terminal 22, may comprise a notification or other content defined by an owner of the information server, such as the mobile server 11.

In an embodiment, a mobile publisher, or the owner of the information server, may define or set permanent and/or temporary data in the gateway or in an associated database. The data may be defined or set using any appropriate means. Examples of appropriate means and data may comprise, but are not limited to, typing a character spring such as a text message, taking a photo using camera means of the terminal, introducing another photo or an image, recoding a moving image, such as a video, or recording an audible message. Further examples may comprise defining for a message a background color or picture, a particular font or text color, and so on.

In an embodiment, the mobile publisher may log into a portal of the reverse proxy, such as the gateway 40, and manage properties concerning what should be shown to browsers when the web server 11 is offline.

In an embodiment, the reverse proxy may host a web service to which anyone can connect. After authentication, one can manage properties via a user interface of the web service. The user interface for managing may be a part of a mobile server application package, running on the mobile terminal.

Furthermore, being online requires a protocol between the mobile terminal and the reverse proxy. In an embodiment, said protocol may be provided with a capability to manage said data defined or set by the mobile publisher. Also in this embodiment, a user interface may be a part of the mobile server application package.

Any of the above embodiments may be suitable for managing permanent properties. Permanent properties may be require that a user edit the data as long as the user needs and wants and that the data remains defined until changed.

Using the web service or providing said protocol with capability to manage said data may provide adequate solutions for managing temporary properties. Temporary property or data may be defined as a property that can be quickly defined and has implicitly defined duration, after which that temporary data is not used any more. For example, when the mobile publisher wishes to go offline, a simple dialog may pop up asking “Do you want to make a personal leave note?”. Upon selecting yes, the mobile publisher may have a quick and easy way to enter a small sentence, take picture or record an audio or video to be sent as information to a requesting terminal. Before the mobile server application closes, or goes offline, the mobile server may send the temporary data to the reverse proxy, such as the gateway 40, or the database associated with the reverse proxy.

In a further embodiment, the gateway 40 may provide information about the attempts to access the web server the gateway observed and/or about the information recorded by the gateway relating to requesting terminals, which requested to be informed when the web server in the mobile terminal 12 becomes available again. The web server mobile terminal 12 may then send a notification about availability of the web server directly to the requesting terminal 22. A notification may be sent to the requesting terminal 22, for example, by means of SMS, MMS, e-mail or SIP.

In an embodiment, the requesting terminal 22 may be allowed to leave a note to be forwarded to the web server 11 when the web server becomes available again. In an exemplifying embodiment, the web-server 11 in the mobile phone 12 may be accessible as a HTTP server, such as http://john.domain.xyz. In the system this may be handled such that all domain name lookups of the form *.domain.xyz cause the IP address of the gateway 40 computer to be returned. When the browser 22, 32 then contacts the gateway 40, which acts as an HTTP server, or as a so-called reverse proxy, the HTTP request will still in its Host field contain the URL http://john.domain.xyz. Hence, the gateway is able to deduce that the request is intended for the phone known as “john”.

If the mobile terminal 12 and thereby the web server 11 now is offline, the gateway 40 can return unavailability information, such as a page with some default offline note, or a custom note if the phone owner has specified such. This unavailability information may be augmented with a possibility to leave a note. The mechanism for leaving a note may be an HTML form or the like. The mechanism may further comprise various elements for personalizing or making more informative the unavailability information, for example in accordance with the above embodiments.

If a user of the browser 22, 32 chooses to leave a note, the note is received and stored, for example, in a database associated with the gateway 40. The note may be indexed with the identifier of the mobile terminal 12 for which the note is intended.

When the mobile terminal 12 in question contacts the gateway 40 and comes online again, the notes intended for the mobile terminal 12 may be transferred as a part of a connection initiation to the mobile terminal 12. The notes might be shown to a user of the mobile terminal 12, for example, by a custom application or they might appear in a regular inbox receiving messages, such as SMS or MMS messages.

The embodiments of requesting to be sent a notification when the web server becomes available again and the embodiment of leaving a note to be forwarded to the web server 11 may be combined in one mechanism. In an alternative, separate mechanisms may be used.

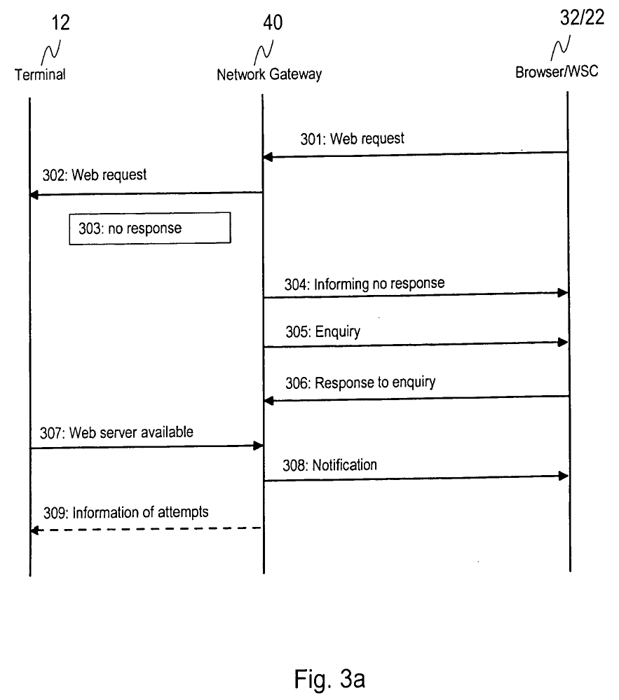

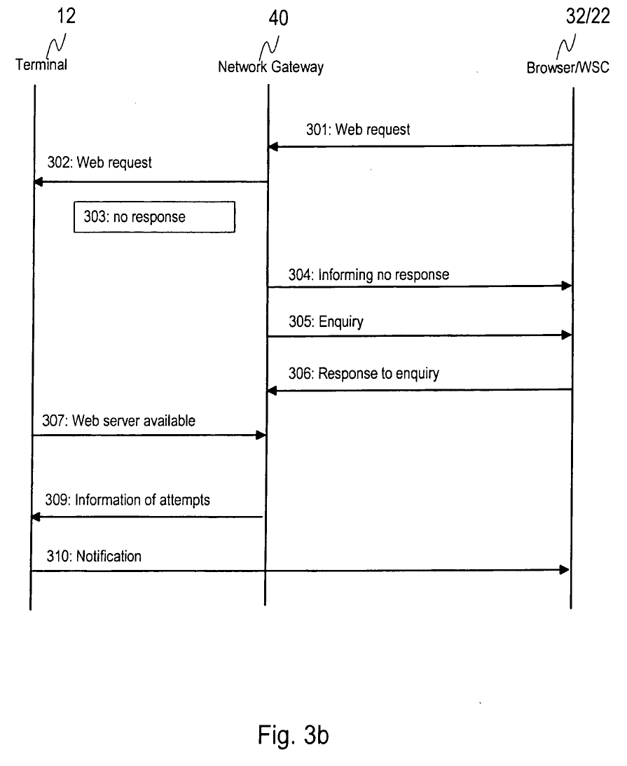

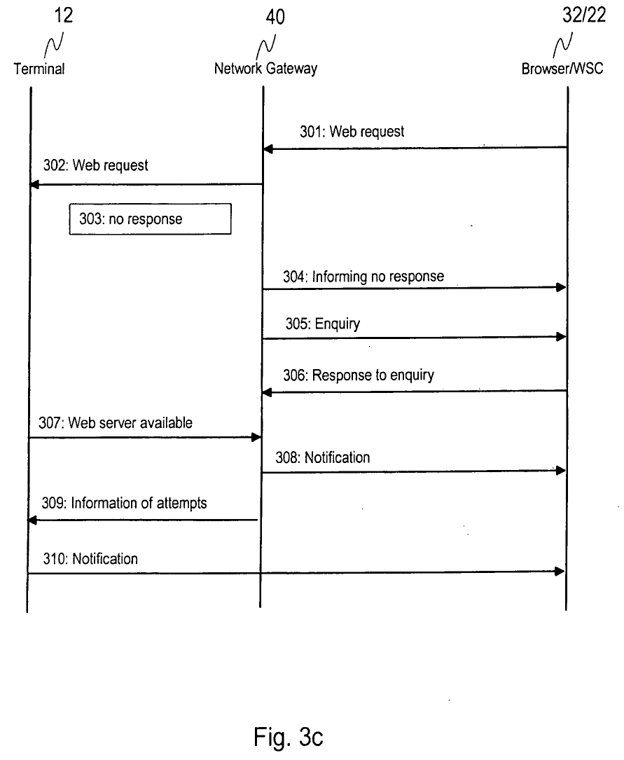

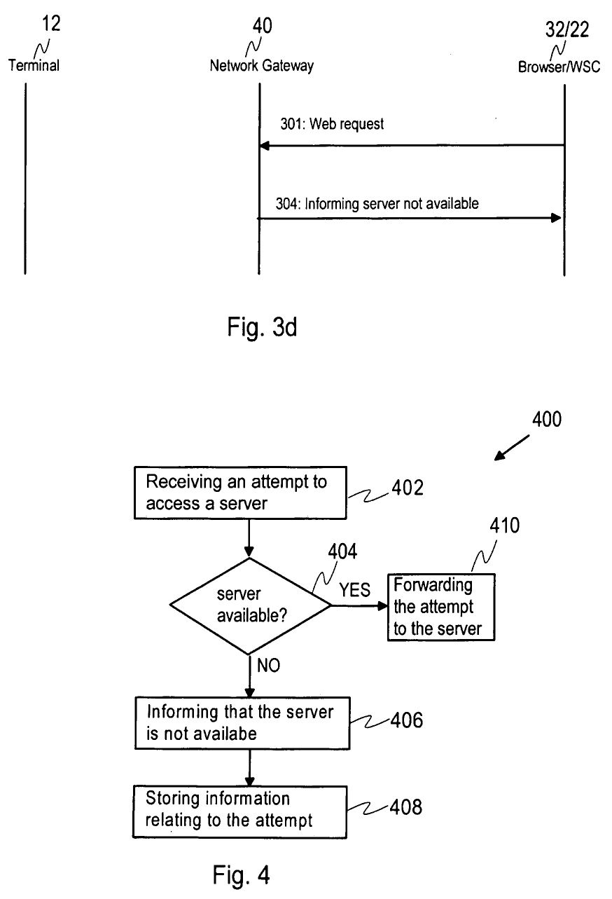

FIGS. 3a-3c show exemplifying signaling flows according to an embodiment of the invention. In signal 301, a request to access the web server is transmitted from the requesting terminal, such as the browser 32 or the WSC 22, and received in the gateway 40. In signal 302, the request is forwarded from the gateway 40 towards the web server mobile terminal 12. When no response is received, referred to as 303, the requesting terminal 22, 32 is informed accordingly in signal 304. In signal 305, which can be also combined with the signal 304, the gateway 40 may further enquire whether the requesting terminal 22, 32 requests to be notified when the web server becomes available. The requesting terminal 22, 32 may send a response in signal 306. Signals 305 and 306 may together comprise a dialog of one or more enquiries and responses. For example, the gateway may further ask an address to which the requesting terminal wants to receive the response. The address may be the identification of the requesting terminal or another address, such as a mobile number of a user using a browser for requesting the access. In signal 307, the web server mobile terminal 12 may inform the gateway 40 of becoming available again.

The signal 305 may or may not comprise an option of leaving a note. The signal 306 may or may not comprise the note, respectively.

The gateway 40 stores information relating to attempts to access the web server during a period of unavailability of the web server. The gateway 40 may store information on all the attempts. In an alternative, the gateway 40 may store information on only the attempts, which are associated with an enquiry and a response from the requesting terminal.

In a first embodiment shown in FIG. 3a, the gateway 40 may notify, in signal 308, the requesting terminal 22, 32, which had responded and wanted to be notified when the web server becomes available again. In this embodiment, signal 309 may be optional. In signal 309, the gateway may transmit information relating to attempts stored by the gateway during the period of unavailability to the web server mobile terminal 12. If the requesting terminal has left a note, also the note may be transmitted to the web server mobile terminal 12 in signal 309, or separately in another signal.

In a second embodiment shown in FIG. 3b, signal 308 is omitted. The gateway 40 does not notify the requesting terminals 22, 32, but transmits information relating to attempts stored by the gateway during the period of unavailability to the web server mobile terminal 12 in signal 309 after having been informed about the availability in signal 307. In signal 310, the web server mobile terminal 12 may then notify the requesting terminals 22, 32 about the availability of the web server.

In a third embodiment shown in FIG. 3c, the gateway 40 may notify, in signal 308, the requesting terminal 22, 32, which had responded and wanted to be notified when the web server becomes available again. In signal 309, the gateway may transmit information relating to attempts stored by the gateway during the period of unavailability to the web server mobile terminal 12. In signal 310, the web server mobile terminal 12 may also contact the requesting terminals 22, 32.

In a further embodiment shown in FIG. 3d, the gateway 40 may know or determine that the web server 11 is not available, for example not online, without forwarding the request to the web server mobile terminal 12. Signal 302 of FIGS. 3a-3c may be omitted in this embodiment. The gateway may send information that the web server is not available directly back to the requesting terminal 22, 32, in signal 304. Signaling may then continue as in any of the FIGS. 3a-3c, or in another appropriate manner. In an embodiment, the gateway 40 may allow fetching said information from the gateway, for example, by browsing.

FIG. 4 shows a method 400 according to an embodiment of the invention. Steps of the method 400 may be performed in the gateway 40 or in another appropriate network element, which is adapted to be available continuously. In step 402, an attempt to access an information server is received. In step 404, it is verified whether the information server is available. If the information server is not available, it is informed, in step 406, that the information server is not available. In step 408, information relating to the attempt is stored. If the information server is available, the attempt to access may be forwarded to the information server in step 410.

Embodiments of the invention may be performed, at least in part, by means of a computer program comprising program code means for performing any of the steps according to embodiments when the program is run on a computing means.

Although the invention has been described in the context of particular embodiments, various modifications are possible without departing from the scope and spirit of the invention as defined by the appended claims. In particular, even if a mobile telephone is mainly used as an exemplifying device providing the server, embodiments of the invention may be implemented in another appropriate communication device. Furthermore, embodiments of the invention may provide advantages when implemented in any information server, in some cases even in a fixed web server.

1. A method for monitoring access to an information server, the method comprising:
receiving an attempt to access an information server;
determining whether the information server is available;
informing a party, from which the attempt was received, that the information server is not available, when the information server is not available; and
storing information relating to the attempt.

2. The method according to claim 1, wherein the step of storing comprises storing information relating to the party, from which the attempt was received.

3. The method according to claim 2, wherein the step of informing comprises sending a notification defined by an entity, which is able to control of the information server.

4. The method according to claim 2, wherein the step of informing comprises enquiring whether the party requests to be sent a notification when the information server becomes available.

5. The method according to claim 4, wherein the step of enquiring comprises enquiring address information relating to an address where said party requests to be informed.

6. The method according to claim 4, wherein the step of enquiring comprises providing one of a form to be filled in and a selectable form.

7. The method according to claim 6, wherein the step of providing comprises providing a hypertext markup language form.

8. The method according to claim 4, further comprising receiving a response in response to the step of enquiring.

9. The method according to claim 1, further comprising receiving availability information informing that the information server is available.

10. The method according to claim 9, further comprising sending a notification to the party, from which the attempt was received, when the availability information is received.

11. The method according to claim 10, wherein the step of sending comprises sending the notification by means of at least one of short message service, multimedia messaging service, electronic mail and instant messaging.

12. The method according to claim 1, further comprising providing the information relating to the attempt to the information server.

13. The method according to claim 1, further comprising providing the information relating to the attempt to an information server owner.

14. The method according to claim 2, wherein the step of enquiring comprises allowing the party to leave a note to be forwarded to the information server when the information server becomes available.

15. The method according to claim 14, wherein the step of enquiring comprises providing a form to be filled.

16. The method according to claim 14, further comprising transmitting the note to the information server when the information server becomes available.

17. The method according to claim 16, further comprising providing the note to an information server owner by at least one of a custom application and in a message inbox associated with the information server.

18. The method according to claim 1, wherein the step of determining comprises forwarding the attempt towards the information server.

19. The method according to claim 1, wherein the step of receiving comprises receiving an attempt to access a mobile information server.

20. The method according to claim 1, further comprising allowing fetching availability information informing that the information server is available.

21. A computer program, embodied on a computer readable medium, said computer program controlling a computing system to perform the steps of:
receiving an attempt to access an information server;
determining whether the information server is available;
informing a party, from which the attempt was received, that the information server is not available, when the information server is not available; and
storing information relating to the attempt.

22. A gateway for monitoring access to an information server in a communications system, the gateway configured to:
receive an attempt to access an information server;
determine whether the information server is available;
inform a party, from which the attempt was received, that the information server is not available, when the information server is not available; and
store information relating to the attempt.

23. A gateway for monitoring access to an information server in a communications system, the gateway comprising:
receiving means for receiving an attempt to access an information server;
determining means for determining whether the information server is available;
informing means for informing a party, from which the attempt was received, that the information server is not available, when the information server is not available; and
storing means for storing information relating to the attempt.

24. A gateway for monitoring access to an information server in a communications system, the gateway comprising:
a receiver for receiving an attempt to access an information server;
a processor for determining whether the information server is available;
a transmitter for informing a party, from which the attempt was received, that the information server is not available, when the information server is not available; and
a memory for storing information relating to the attempt.

25. A method for managing an information server, the method comprising:
receiving information relating to an attempt to access an information server, which attempt occurred during a period of unavailability of the information server; and
informing a party, from which the attempt was received, that the information server is available again.

26. The method according to claim 25, wherein the step of informing comprises informing a gateway monitoring access to the information server.

27. The method according to claim 25, wherein the step of receiving comprises receiving information relating to the party, which initiated the attempt.

28. The method according to claim 27, wherein the step of informing comprises informing the party, which initiated the attempt.

29. The method according to claim 25, comprising implementing the information server in a mobile communication device.

30. A computer program, embodied on a computer readable medium, said computer program controlling a computing system to perform the steps of:
receiving information relating to an attempt to access an information server, which attempt occurred during a period of unavailability of the information server; and
informing a party, from which the attempt was received, that the information server is available again.

31. An information server for a communication system, the information server configured to:
receive information relating to an attempt to access an information server, which attempt occurred during a period of unavailability of the information server; and
inform a party, from which the attempt was received, that the information server is available again.

32. An information server for a communication system, the information server comprising:
receiving means for receiving information relating to an attempt to access an information server, which attempt occurred during a period of unavailability of the information server; and
informing means for informing a party, from which the attempt was received, that the information server is available again.

33. An information server for a communication system, the information server comprising:
a receiver for receiving information relating to an attempt to access an information server, which attempt occurred during a period of unavailability of the information server; and
a transmitter for informing a party, from which the attempt was received, that the information server is available again.

34. The information server according to claim 31, wherein the information server is implemented in a mobile communication device.

35. The information server according to claim 32, further comprising defining means for defining a notification to be sent to the party, from which the attempt was received.

36. The information server according to claim 35, wherein the defining means comprise at least one of typing means, camera means, sound recoding means, short message service means and multimedia messaging service means.

37. The information server according to claim 35, wherein the notification comprises at least one of a character string, an image, a moving image, an audible message, a background color and a font.

38. A mobile communication device hosting an information server, the information server configured to:
receive information relating to an attempt to access an information server, which attempt occurred during a period of unavailability of the information server; and
inform a party, from which the attempt was received, that the information server is available again.
